(19) United States
(12) Patent Application Publication
(10) Pub. No.: US 2012/0215452 A1
(43) Pub. Date: Aug. 23, 2012

(54) SYSTEM AND METHOD FOR WATERFLOOD MANAGEMENT

(75) Inventors: Daoyuan Zhai, Los Angeles, CA (US); Jerry M. Mendel, Culver City, CA (US)

(73) Assignee: University of Southern California, Los Angeles, CA (US)

(21) Appl. No.: 13/363,340

(22) Filed: Jan. 31, 2012

Related U.S. Application Data
(60) Provisional application No. 61/438,174, filed on Jan. 31, 2011.

(51) Int. Cl. G06F 19/00; G06F 17/10; G01V 9/00; G06G 7/48

(52) U.S. Cl. 702/12; 703/10; 703/2

(57) ABSTRACT

A method of producing hydrocarbons in a reservoir includes determining a relationship between an injection well and a producing well based on an injection rate and a production rate wherein the relationship is filtered to produce a filtered value, and a modified state variable model is selected for each relationship to produce a positive relationship value to determine the production rate.

### BACKGROUND

1. Field

The present invention relates generally to reservoir management and more particularly to methods of modeling secondary production.

2. Background

This application claims priority to U.S. Provisional Application 61/438,174 filed Jan. 31, 2011 the entire contents of which are incorporated herein by reference.

Hydrocarbon extraction is typically understood as a three stage process. In the primary stage, a reservoir is drilled, and oil and gas are recovered as a result of natural pressures and flows into the drilled well. In the secondary phase, pressure is applied to force more oil and gas from the reservoir. Water, gas, or other fluids may be pumped in to increase the pressure so that more of the hydrocarbons may be recovered. In the tertiary phase, steam, CO₂ or other materials may be injected into the reservoir to further increase production.

### SUMMARY

An aspect of an embodiment of the present invention includes a method of producing hydrocarbons in a reservoir including determining a relationship between an injection well and a producing well based on an injection rate and a production rate wherein the relationship is filtered to produce a filtered value, and a modified state variable model is selected for each relationship to produce a positive relationship value to determine the production rate.

Aspects of embodiments of the present invention include computer readable media encoded with computer executable instructions for performing any of the foregoing methods and/or for controlling any of the foregoing systems.

### DESCRIPTION OF THE DRAWINGS

Other features described herein will be more readily apparent to those skilled in the art when reading the following detailed description in connection with the accompanying drawings, wherein:

FIG. 1 is a representation of a reservoir model relating a single production well to a plurality of injection wells;

FIGS. 2a-2c illustrate an extended Kalman smoother wherein FIG. 2a illustrates a predictor step, FIG. 2b illustrates a corrector step and FIG. 2c illustrates an overall procedure for the EKF for measurements at all time points;

FIG. 3 illustrates a fixed-interval EKS for measurements over an interval between 1 and D;

FIGS. 4a and 4b illustrate a producer (P-130) and associated injectors I-n (4a) and injectors remaining after an elimination process (4b);

FIGS. 5a and 5b illustrate IPR values (5a) and normalized IPR values (5b) for the injectors I-n of FIG. 4a;

FIGS. 6a and 6b illustrate IPR values (6a) and normalized IPR values (6b) for the injectors of FIG. 4b;

FIG. 7 illustrates historical prediction matching;

FIG. 8a shows a portion of the prediction matching process illustrated in FIG. 7 and FIG. 8b illustrates prediction error for the prediction matching of FIG. 8a;

FIG. 9 is a table of values for prediction error for the historical prediction matching process;

FIG. 10 is an illustration of forward prediction and backward smoothing in accordance with an embodiment of the invention;

FIG. 11 is an illustration of the mixed application of the EKF and IEKFS methods for data of varying density; and

FIG. 12 is an illustration of the use of EKF with intermittent measurements.

### DETAILED DESCRIPTION

In secondary and tertiary production, it is useful to understand relationships between injection wells (where water, steam or other materials are injected into a reservoir) and production wells (where hydrocarbons are recovered from the reservoir). In this regard, there have been many approaches to modeling flows between injectors and producers, taking into account fluid properties, capillary pressures, fluid contacts, porosity and subsurface geological structures. It is possible to directly measure fluid connectivity, for example using tracer fluids. On the other hand, direct measurements are expensive and slow, and may tend to detract from production operations.

In one approach, injection rates are correlated to production rates, and a number of mathematical approaches to modeling the relationship between the input and output have been taken. In an extended Kalman filter (EKF) approach, N injectors are assumed to influence a particular producer, and can be modeled using 2N parameters to characterize the impulse response of the system.

The inventors have determined that there are issues with the EKF approach, specifically that estimates of the injector-producer relationship (IPR values) may take on negative values, a non-physical result; that it may be difficult to determine whether a particular injector is related (or is related in an important way) to a particular producer; and that estimated IPR values may sum to greater than one for a given group of injectors, which is also a non-physical result. By estimating the square root of IPR values directly, negative values for IPR can be eliminated. Constraining the state vectors by requiring that all values of IPR and a fall between 0 and 1 for all time points, and all injector-centered sums of IPR values must also fall in the [0,1] interval can eliminate the second type of non-physical results.

Therefore, in an embodiment, the present invention provides a method to apply an iterative extended Kalman filter and smoother (IEKFS) to dynamically interpolate data between two available measured values. A production rate is modeled as a state variable for each of a series of time points, and the EKF is applied to forward-estimate the production rate, then an EKS is used to backward-estimate the production rate. The resulting interpolated data can be used in a variety of signal processing-based approaches.

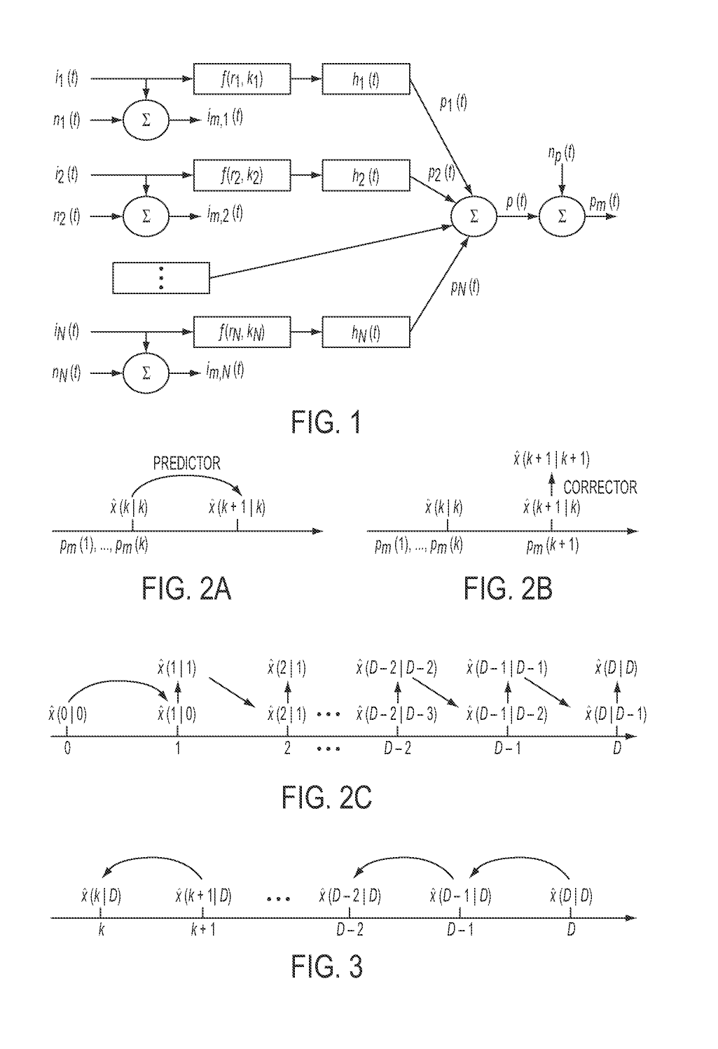

A reservoir may be modeled in accordance with the Liu-Mendel model, which assumes a producer-centric system having one producer and N injectors as illustrated in FIG. 1, where i₁(t), . . . , i_{N}(t), n₁(t), . . . , n_{N}(t) and i_{m,1}(t), . . . , i_{m,N}(t) are injection rates, injection rate measurement noise, and measured injection rates. The actual production rate, the production rate measurement noise and the measured production rate are shown as p(t), nₚ(t) and pₘ(t). The production for a given injector j is labeled pⱼ^{c}(t)(j=1, . . . N) and f(rⱼ,kⱼ) is a scaling function that determines what portion of the injected material at injector j flows to the producer. The scaling function may be a function of the distance rⱼ and the permeability kⱼ of the formation between the injector and the producer. As will be appreciated, the noise-free data is not available in practice and the measured values are used.

The modeled system characterizing the impulse response is h(t)=bte^{-at} which is discretized and Z-transformed as

$$H ( z ) = \frac{γ {z}^{- 1}}{{( 1 - α {z}^{- 1} )}^{2}}$$

where the parameters a=e^{-aT} and y=baT and T is the sampling period. Thus, the reservoir may be modeled as:

$$P ( z ) = {\sum }_{j = 1}^{N} {P}_{j}^{c} ( z ) = {\sum }_{j = 1}^{N} {H}_{j} ( z ) f ( {r}_{j} , {k}_{j} ) {I}_{j} ( z ) = {\sum }_{j = 1}^{N} \frac{{γ}_{j} f ( {r}_{j} , {k}_{j} ) {z}^{- 1}}{{( 1 - {α}_{j} {z}^{- 1} )}^{2}} {I}_{j} ( z )$$

where P(z),Pⱼ^{r}(z)andIⱼ(z) are the Z-transforms of the total production rate p(k), the production rate from the j^{th} injector and the injection rate of the j^{th} injector respectively. By appropriate manipulation of the parameters and using the measured injection rates, IPRⱼ can be shown to be

$$\frac{{γ}_{j}^{′}}{{( 1 - {α}_{j} )}^{2}} .$$

In an embodiment, an initial set of injectors are selected as potentially contributing to a given producer. Typically, this selection may rely on the knowledge of subject-matter experts based on information relating to reservoir structure. For example, in a reservoir having known subsurface parallel fractures along a known angle, it may be expected that injectors aligned along the fracture lines will tend to contribute to producers aligned along those lines.

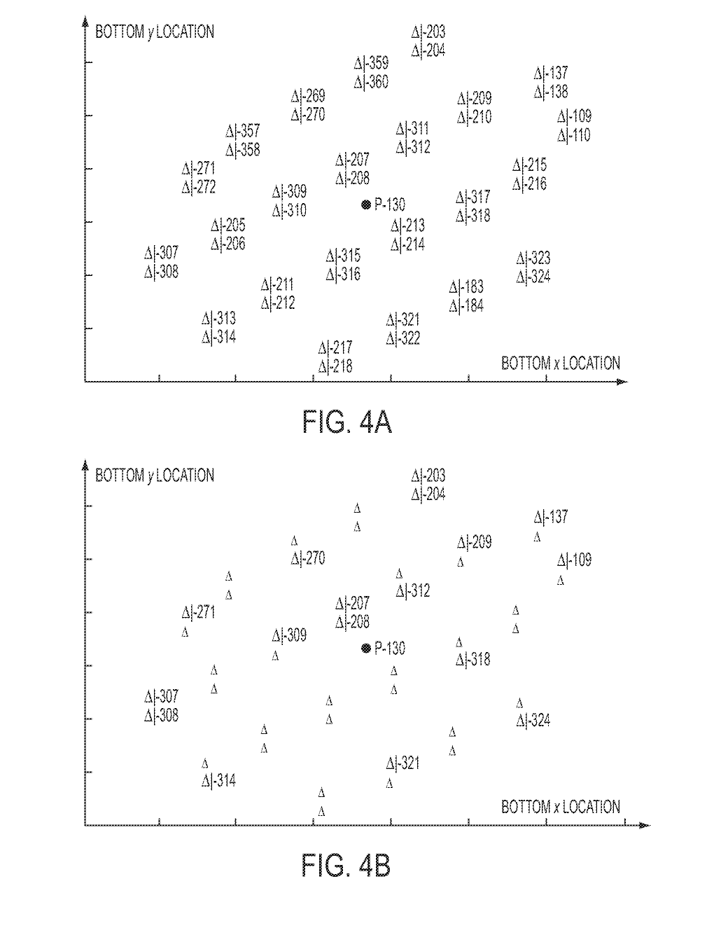

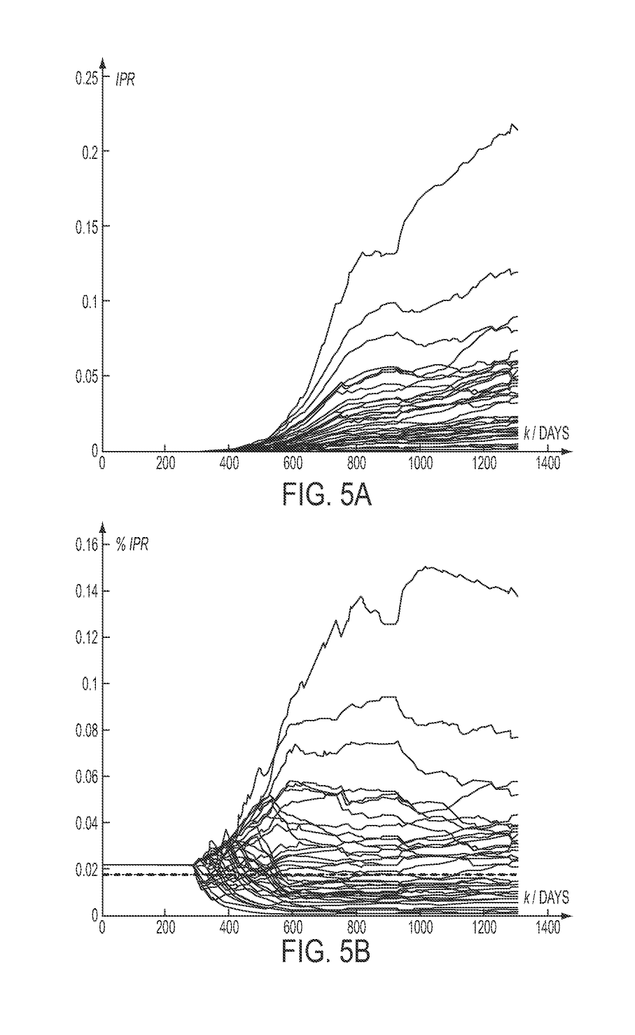

FIG. 4a illustrates a producer centric model of a field having a single producer (P-130) and a plurality of injection wells 1-N where each injector has a short and a long completion illustrated as respective upper and lower triangles at each location. IPR curves are generated for all of the completions as shown in FIG. 5a. Then, as shown in FIG. 5b, a threshold is applied (dotted line) to the normalized IPR curves (i.e., each curve divided by the sum of all of the IPR curves) and those completions having IPR values lower than the threshold are eliminated. The remaining completions are shown in FIG. 4b. For N injectors, an initial estimate of the impact of each injector can be set to be 1/N and the threshold may be set, for example, at 80% of 1/N as illustrated in FIG. 5b. In the illustrated example, there are 46 initial completions, and the threshold is set to 1.74% resulting in elimination of all but 17 completions (shown in FIG. 4b).

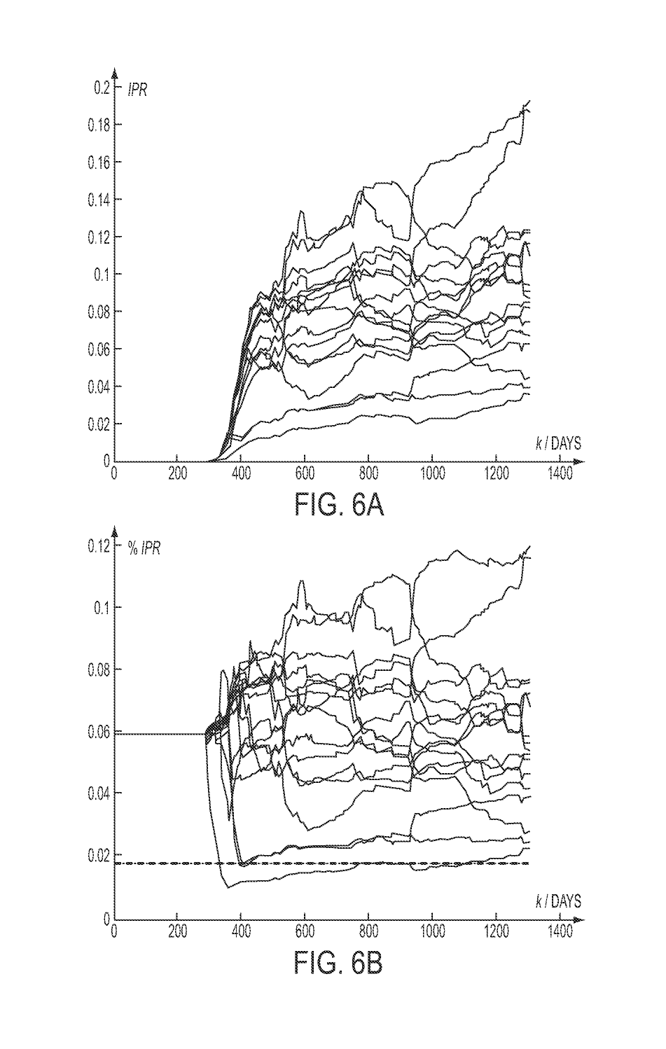

In this example, once the low-impact completions are eliminated, the EKF is applied to the remaining 17 completions. The resulting IPR values are shown in FIG. 6a. Though a portion of three of the IPR curves are shown to be below the threshold, the mean value for the most recent time periods exceeds the threshold so these completions are retained. In an embodiment, completions falling below the threshold can be iteratively eliminated based on a similar (e.g., 80%/N) threshold, where N remains the initial number of injectors. Once an equilibrium is reached and no further injectors are eliminated, the iterative process of elimination may be halted.

For each producer, the initial set of injectors selected prior to the thresholding process can be selected based on location. For example, injectors positioned within an elliptical region can be chosen. In an example, the ellipse may be 500×700 feet, and the ellipse may be scaled by a scalar value s. In theory, s can be finely discretized and may be selected to range from a small value to a large value such that a minimized point of an objective function is a global minimum. Large numbers of values for s tends to be computationally expensive. The inventors have determined that for s={0.5, 0.6, 0.7, 0.8, 0.9 and 1.0} a sufficient number of injectors can be included (at s=1). Below about 0.5, only a few injectors are included and lower values for s are not typically useful. As will be appreciated, this lower threshold will tend to depend on the specific site and the density of injectors

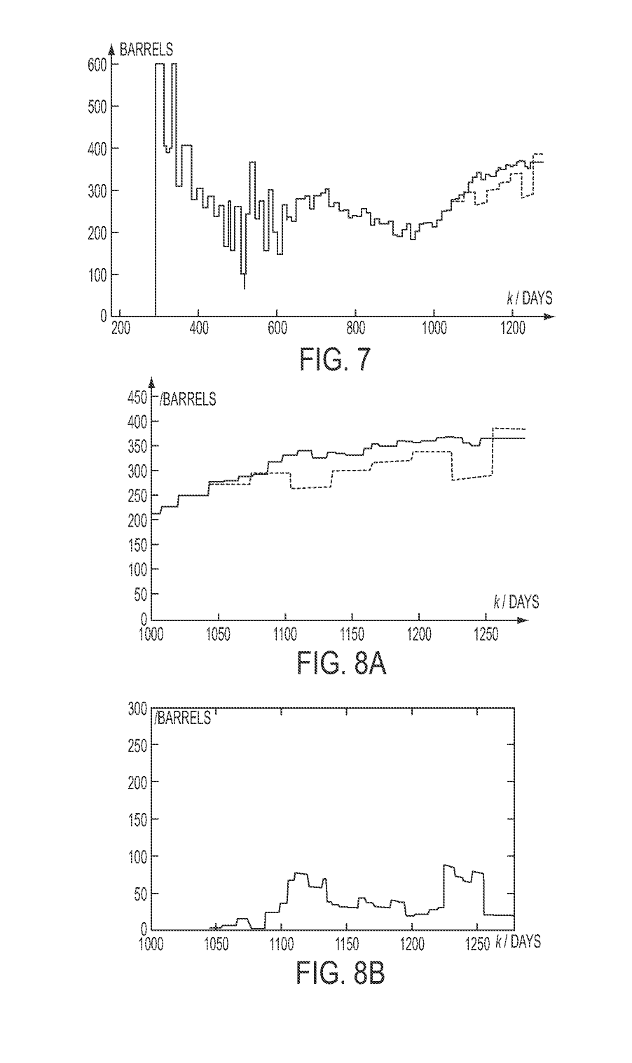

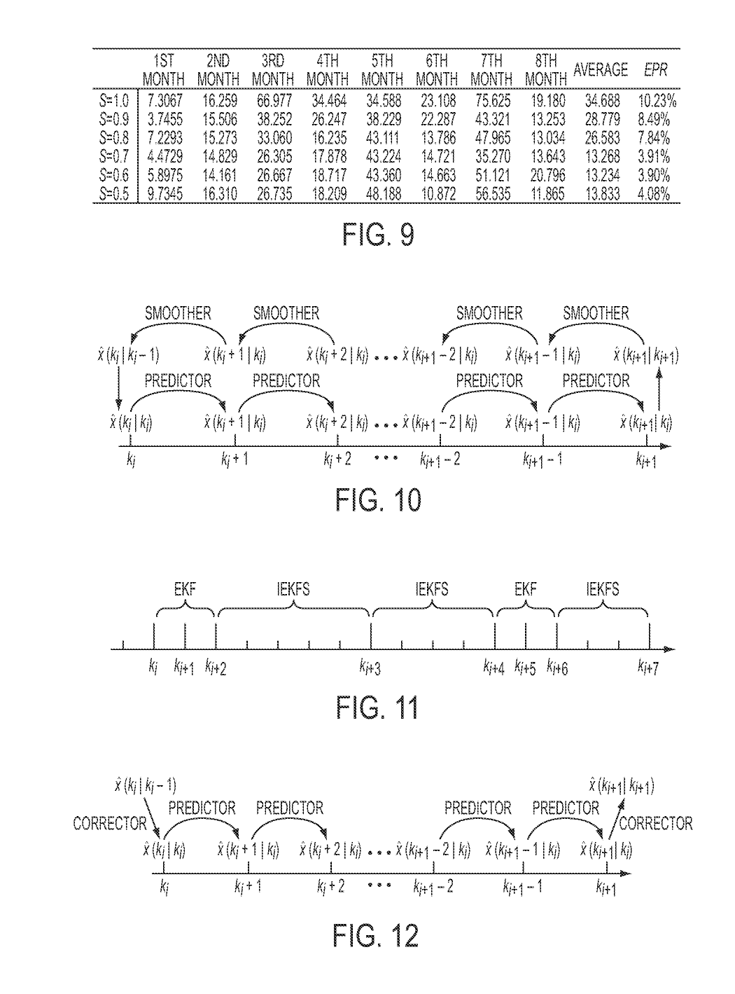

In an embodiment, validation testing may be performed by using a history matching process. In this approach, a past injection rate change is used as a starting point for a production “forecast” where the time of the forecast corresponds to a time after the historical starting point but before the present time. The forecast value may then be compared to a measured production rate using a predictor equation from the EKF. This is illustrated in FIG. 7 where the solid line represents measured data and the dotted line represents forecast data. The forecast data is shown more clearly in FIG. 8a, and prediction error is plotted in FIG. 8b. FIG. 9 is a table listing average prediction error and a mean error production ratio (EPR). The EPR for s=1 is about 10%, which falls within the expected noise level for actual production measurements.

For the selected group of injectors, a state vector model is generated for the injector-producer pair system. The EKF is applied to estimate the state vector at a time k+1 using a predictor based on measurements up to the time k, and a corrector which re-estimates x(k+1). These are illustrated in FIG. 2a (predictor) and 2b (corrector). While the EKF estimates the state vector in a forward manner, the EKS performs a reverse estimation process. Future measurements are used to determine estimates for earlier time points, and thus is necessarily not a real-time estimation method. Once measurements over the interval between 1 and D are obtained, an estimate of the state vector can be determined based on the available measurements as shown in FIG. 2c.

In practice, the measurements at each time k are intermittent, so the corrector can only be applied at the times k corresponding to measurements. On the other hand, the predictor may be applied for all time points. This is shown in FIG. 9 for a series of time steps kᵢ. Thus, for a given interval the estimation procedure is shown in FIG. 10 in which x is forward estimated for each time period using the predictor (lower row of FIG. 10). Once actual data for each k becomes available, x is computed and backward estimated using the smoother (upper row of FIG. 10). This process can be iterated until the state estimates converge, or a stopping criterion is reached. A final estimate can then be used to determine a gross production rate based on the sum of the individual estimates.

In an embodiment, measurement sets may have portions which are intermittent while other portions are consecutive. In this case, EKF state estimation is used for those portions having consecutive measurements (i.e., there is no need for interpolation) and iterative extended Kalman filtering and smoothing (IEKFS) is used for the intermittent portions. This is illustrated in FIG. 11. FIG. 12 illustrates the use of EKF with intermittent measurements with the corrector only applied at time points where measurements are available (e.g., kᵢ and k₁+1).

In an embodiment, a sampling frequency of the production rate may be on the order of several days. As an example, the frequency may be between 1 and 15 days, and more particularly, between 5 and 10 days. By using the IEKFS method to interpolate between available measurements, a frequency of measurement may be reduced compared to EKF alone.

As will be appreciated, the method as described herein may be performed using a computing system having machine executable instructions stored on a tangible medium. The instructions are executable to perform each portion of the method, either autonomously, or with the assistance of input from an operator. In an embodiment, the system includes structures for allowing input and output of data, and a display that is configured and arranged to display the intermediate and/or final products of the process steps. A method in accordance with an embodiment may include an automated selection of a location for exploitation and/or exploratory drilling for hydrocarbon resources.

Those skilled in the art will appreciate that the disclosed embodiments described herein are by way of example only, and that numerous variations will exist. The invention is limited only by the claims, which encompass the embodiments described herein as well as variants apparent to those skilled in the art. In addition, it should be appreciated that structural features or method steps shown or described in any one embodiment herein can be used in other embodiments as well.

1. A method of modeling a subsurface formation having one or more injection wells by which a material may be injected into the formation to promote extraction of a resource present in a reservoir in the formation from one or more production wells, the method comprising:
determining a relationship between the production wells and the injection wells based on a measured injection rate and a measured production rate;
filtering the determined relationship using an extended Kalman filter to determine an injector-producer relationship value for a plurality of pairs of injection wells and production wells, the filtering including constructing a modified state variable model using the determined relationship and wherein state variables of the modified state variable model are selected so that each determined injector-producer relationship value is positive; and
determining a production rate of the resource using the determined injector-producer relationship value for each pair.

2. The method of claim 1, wherein a square root of each relationship value is selected as a state variable in the modified state variable model.

3. The method of claim 1, further comprising selecting an initial plurality of injection wells contributing to extraction at a production well.

4. The method of claim 3, wherein the initial plurality of injection wells is selected on the basis of measurements of injection rates and production rates.

5. The method of claim 3, comprising determining the relationship and filtering the determined relationship for each of the selected injection wells.

6. The method of claim 5, comprising, for each of the initial plurality of injection wells, calculating a mean value of the injector-producer relationship value over a selected period of time.

7. The method of claim 6, further comprising selecting injectors having a calculated mean value greater than a threshold value.

8. The method of claim 7, comprising iterating the determining the relationship, the filtering the determined relationship, and the calculating the mean value until each calculated mean value is greater than the threshold value.

9. The method of claim 1, further comprising constraining the modified state variable model such that a sum of the injector-producer relationship values for a selected injector and each related producer is less than or equal to one.

10. The method of claim 1, wherein the filtering the determined relationship comprises interpolating production rates between two measured production rates by iteratively filtering the relationship for each pair using an extended Kalman filter and an extended Kalman smoother.

11. The method of claim 1, wherein the determined relationship value for each injector-producer pair is determined on the basis of an auto-regressive model.

12. A machine readable tangible medium encoded with machine executable instructions for performing the method of claim 1.

13. A computer system comprising:
a tangible machine readable memory;
a processor, operatively coupled to the memory and programmed to perform the method of claim 1.

14. A system comprising:
at least one injection well, configured and arranged to pump material into a subsurface formation to promote production of a resource present in the formation;
at least one production well, configured and arranged to produce the resource from the formation;
at least one injection rate detector, configured and arranged to measure a rate of material injection into the formation;
at least one production rate detector, configured and arranged to measure a rate of production from the formation;
a computing system, configured and arranged to:
receive the determined rate of material injection and the determined rate of production and to determine a relationship between the production well and the injection well based on the measured injection rate and the measured production rate;
filter the determined relationship using an extended Kalman filter to determine an injector-producer relationship value for a plurality of pairs of injection wells and production wells, the filtering including constructing a modified state variable model using the determined relationship and wherein state variables of the modified state variable model are selected so that each determined injector-producer relationship value is positive; and
determine a production rate of the resource using the determined injector-producer relationship value for each pair.
